(19) United States
(12) Patent Application Publication
(10) Pub. No.: US 2017/0034849 A1
(43) Pub. Date: Feb. 2, 2017

(54) Enhanced Dedicated Channel (E-DCH) Transmissions Related to Tune-Away Occurrences

(71) Applicant: QUALCOMM Incorporated, San Diego, CA (US)

(72) Inventors: Sitaramanjaneyulu Kanamarlapudi, San Diego, CA (US); Shailendra Singh Verma, Hyderabad (IN); Vaishakh Rao, San Diego, CA (US); Jing Huang, San Diego, CA (US); Hemanth Kumar Rayapati, San Diego, CA (US); Arvindhan Kumar, San Diego, CA (US); Nikhil Pai, San Diego, CA (US)

(21) Appl. No.: 14/933,109

(22) Filed: Nov. 5, 2015

(30) Foreign Application Priority Data
Jul. 31, 2015 (IN) 3953/CHE/2015

(51) Int. Cl. H04W 72/14; H04L 5/00

(52) U.S. Cl. CPC H04W 72/14; H04L 5/0055; H04W 88/06

(57) ABSTRACT

Various embodiments provide methods for a multi-Subscription Identity Module (SIM) wireless communication device for managing data exchanges with a network when an enhanced dedicated channel is requested on a first subscription. The methods may include performing operations during a testing phase to determine whether an enhanced dedicated channel grant is valid after a tune-away to a second subscription is completed, while transmitting data using the enhanced dedicated channel presuming that the enhanced dedicated channel grant is valid during the testing phase. The methods may include recording a list of protocol data units (PDUs) corresponding to data transmitted using the enhanced dedicated channel during the testing phase. The list of PDUs may be cleared and data exchanged with the network in response to determining that the enhanced dedicated channel grant is valid. Otherwise, the multi-SIM wireless communication device may request another enhanced dedicated channel grant.

### RELATED APPLICATIONS

The present application claims the benefit of priority to Indian Provisional Patent Application No. 3953/CHE/2015, entitled “Enhanced Dedicated Channel (E-DCH) Transmissions Related to Tune-Away Occurrences” filed Jul. 31, 2015, the entire contents of which are hereby incorporated by reference.

### BACKGROUND

Some wireless communication devices (e.g., smart phones, tablet computers, and laptop computers, etc.) include support for two or more radio access technologies (RATs) that enable the devices to connect to two or more radio access networks, such as Long Term Evolution (LTE) networks and Global System for Mobile Communications (GSM) networks. Each RAT may correspond to a network subscription or Subscriber Identity Module (SIM). For example, a first subscription (e.g., a GSM network subscription) may use a transceiver of the wireless communication device to communicate with a GSM base station at a first time, and a second subscription (e.g., an LTE subscription) may use the transceiver to communicate with an LTE base station at a second time. Such wireless communication devices having two or more subscriptions or SIMs are often referred to as “multi-SIM wireless communication devices.”

A multi-SIM wireless communication device includes at least one radio frequency (RF) communication circuit (or RF resource) for providing access to separate networks associated with various subscriptions supported by the multi-SIM wireless communication device. One RF resource may be shared between two or more subscriptions. For example, a multi-SIM wireless communication device having two subscriptions configured to use a single RF chain (e.g., a dual-subscription, dual standby (DSDS) device) may be capable of accessing one network associated with either of the two subscriptions at any given time.

When two or more subscriptions of a multi-SIM wireless communication device share a common RF chain, the multi-SIM wireless communication device may periodically tune a transceiver to separate frequencies for the different subscriptions in a “tune-away” process. During a tune-away, the multi-SIM wireless communication device momentarily switches from a first subscription to a second subscription in order to receive or monitor communications for the second subscription, such as pages. During a tune-away, only one subscription can receive communications, while the other one or more subscriptions are temporarily out-of-service, unable to send or receive data.

### SUMMARY

Various embodiments provide methods, devices, systems, and non-transitory process-readable storage media for managing data exchanges with a network when an enhanced dedicated channel (E-DCH) is requested on a first subscription and a tune-away to a second subscription is performed. Various embodiments may include transmitting data using the enhanced dedicated channel for the first subscription during a testing phase that occurs after performing a tune-away to a second subscription, recording (e.g., stored in memory) a retransmit list of protocol data units (PDUs) corresponding to data transmitted using the enhanced dedicated channel during the testing phase, determining whether the enhanced dedicated channel grant for the enhanced dedicated channel is valid for the first subscription by an end of the testing phase, clearing the retransmit list of PDUs in response to determining that the enhanced dedicated channel grant is valid for the first subscription, exchanging data with the network in response to determining that the enhanced dedicated channel grant is valid for the first subscription, and exchanging transmissions with the network to request a second enhanced dedicated channel grant in response to determining that the enhanced dedicated channel grant is not valid for the first subscription.

In some embodiments, the testing phase may coincide with a SYNC-AA procedure. In some embodiments, the SYNC-AA procedure may have a duration of 40 ms. In some embodiments, determining whether the enhanced dedicated channel grant is valid for the first subscription may include determining whether a Hybrid Indicator Channel acknowledgment (HICH ACK) message is received corresponding to the first subscription during the testing phase, determining that the enhanced dedicated channel grant is valid in response to determining that that a HICH ACK message is received corresponding to the first subscription during the testing phase, and completing the SYNC-AA procedure in response to determining that a HICH ACK message is not received corresponding to the first subscription during the testing phase.

In some embodiments, the method may further include re-transmitting data associated with PDUs on the retransmit list of PDUs after the second enhanced dedicated channel grant is received following exchanges of transmissions with the network to request the second enhanced dedicated channel grant in response to determining that the enhanced dedicated channel grant was not valid for the first subscription. Following re-transmitting data associated with the PDUs on the list of PDUs, the list of PDUs may be cleared (e.g., removed from memory). In some embodiments, the method may further include determining whether any acknowledge (ACK) messages associated with PDUs on the retransmit list of PDUs have been received during the testing phase, and removing from the retransmit list of PDUs the PDUs associated with ACK messages that are determined to have been received during the testing phase. In some embodiments, the method may further include dropping any currently used common E-DCH resource in response to determining that the enhanced dedicated channel grant is not valid for the first subscription. In some embodiments, the method may further include releasing resources for the enhanced dedicated channel grant for the first subscription in response to exchanging the data with the network using the enhanced dedicated channel grant for the first subscription.

Further embodiments include a computing device configured with processor-executable instructions for performing operations of the methods described above. Further embodiments include a non-transitory processor-readable medium on which is stored processor-executable instructions configured to cause a computing device to perform operations of the methods described above. Further embodiments include a communication system including a computing device configured with processor-executable instructions to perform operations of the methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the claims.

FIG. 1 is a communication system block diagram of a communication network suitable for use with various embodiments.

FIG. 2 is a component block diagram of a wireless communication device suitable for use with various embodiments.

FIG. 3 is a diagram illustrating an exemplary Enhanced Dedicated Channel (E-DCH) procedure suitable for use with various embodiments.

FIG. 4 is a process flow diagram illustrating an embodiment method for a multi-SIM wireless communication device supporting two or more subscriptions configured to use a common RF chain to identify the loss of a network dedicated grant due to a tune-away.

FIG. 5 is a component block diagram of a mobile computing device suitable for use in some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the embodiments or the claims.

The word “exemplary” is used herein to mean “serving as an example, instance, or illustration.” Any implementation described herein as “exemplary” is not necessarily to be construed as preferred or advantageous over other implementations.

The term “multi-SIM wireless communication device” is used herein to refer to a wireless communication device equipped with a processor configured to connect to two or more subscriber identity modules (SIMs) and support two or more subscriptions associated with the SIMs using a shared radio frequency (RF) resource. Examples of multi-SIM wireless communication devices include cellular telephones, wearable devices, smart-phones, web-pads, tablet computers, Internet enabled cellular telephones, cellular-enabled laptop computers, unmanned autonomous vehicles, etc.

Multi-SIM wireless communication devices may be configured to support communications via a plurality of subscriptions associated with various wide area networks (WANs), such as GSM and LTE cellular networks. Network subscriptions are typically be associated with a SIM (or SIM card) or a virtual SIM (VSIM). Multi-SIM wireless communication devices may be configured to support two, three, four, or more subscriptions, each associated with a SIM (or VSIM). Multi-SIM wireless communication devices may use at least one radio resource (or RF resource or RF chain) to enable communications with the plurality of subscriptions.

Multi-SIM multi-standby (MSMS) wireless communication devices support two or more subscriptions by sharing one RF resource, effectively enabling the subscriptions to take turns using the RF resource (e.g., by performing tune-aways). For example, a multi-SIM wireless communication device having two subscriptions and one RF chain (e.g., a dual-subscription, dual standby (DSDS) device) may perform tune-away procedures to provide network connectivity to the first subscription while the second subscription is on an active data call. While some multi-SIM wireless communication devices include more than one RF resource to enable multi-active communications, such devices may be configured to function in a multi-standby mode in which two or more subscriptions share one RF resource. For example, a multi-SIM multi-active wireless communication device configured to support three subscriptions using two RF resources may be configured to provide network connectivity to a first subscription and a second subscription using a first RF resource while a third subscription is given exclusive use of a second RF resource.

In some conventional cellular networks, a multi-SIM wireless communication device may utilize enhanced dedicated channel (E-DCH) operations of the E-DCH transmission in Cell FACH (Forward Access Channel) state protocol of Universal Mobile Telecommunications System (UMTS) in order to request/acquire network resources, transmit data, and release the resources. The E-DCH operations are outlined in 3GPP Technical Specification (TS) 25.319 version 12.2.0 Release 12, section 16 “E-DCH transmission in CELL_FACH state and idle Mode (FDD only)” (January 2015). An E-DCH enhanced random access procedure performed by a multi-SIM wireless communication device may include performing access request preamble transmissions with preamble power ramping; acquisition indication and assignment of a common E-DCH resource; data transmissions over the assigned E-DCH channel; and release of the common E-DCH resource.

In order to support two or more subscriptions using one RF resource, a multi-SIM wireless communication device may perform tune-away operations (or “tune-away(s)”) in which the multi-SIM wireless communication device tunes away from a first network supporting a first subscription to a second network supporting a second subscription in order to enable the second subscription to receive communications (e.g., as pages) and perform network maintenance operations (e.g., measuring and reporting cell signal strengths). For example, the first subscription may be a Wideband Code Division Multiple Access (WCDMA) high-speed (HS) random access channel (RACH) subscription, and the second subscription may be a GSM subscription. During such a tune-away from the first subscription to support the second subscription, the first subscription is unable to receive transmissions from the first network.

In a multi-SIM wireless communication device, when a first subscription is engaged in E-DCH operations (e.g., exchanging messages corresponding to E-DCH resources) with a first network, the first subscription could miss important network messages during tune-aways to a second network supporting a second subscription. In particular, when tuned away during certain phases of the E-DCH procedure for the first subscription (i.e., during a “collision resolution” phase or “collision resolved” phase), a dedicated access grant channel (AGCH) command from the first network may be missed. Such an AGCH command typically controls an absolute (or dedicated) grant for the multi-SIM wireless communication device to communicate using certain network resources associated with the first subscription.

In general, due to the importance of AGCH commands, receipt and decoding of AGCH commands are expected to be received by wireless communication devices with a high probability of success. When the multi-SIM wireless communication device fails to receive an AGCH command (i.e., fails to acquire) and/or otherwise loses the dedicated grant from the network due to tune-away occurrences, the multi-SIM wireless communication device may not have authorization to exchange data using the dedicated network resources corresponding to a dedicated grant. The multi-SIM wireless communication device may then inappropriately utilize general network resources (e.g., enhanced uplink (EUL) resources) without a dedicated grant due to failure to recognize the loss (or failure to acquire) based on a tune-away occurrence. Such inappropriate actions by the multi-SIM wireless communication device may impact the efficiency of the device. For example, the multi-SIM wireless communication device may lose transmissions due to the lack of a proper channel, causing data transmission failures and degraded power use and performance. A failure to identify a lack of a valid dedicated grant by the multi-SIM wireless communication device may also impact the efficiency of the network, as the multi-SIM wireless communication device may use common resources, causing overall system interference (e.g., network resource management) and degradation of key performance indicators (KPI).

Various embodiments provide methods implemented on a multi-SIM wireless communication device for confirming the presence of a valid dedicated grant for E-DCH transmissions after a tune-away. In general, the multi-SIM wireless communication device may be configured to quickly and reliably perform operations during a testing phase to detect the loss of and/or failure to acquire a network dedicated grant during a tune-away occurrence. For example, based on messages associated with certain network synchronizing (“synch”) procedures, the multi-SIM wireless communication device may determine whether the dedicated grant still exists within approximately 40 ms. While detecting whether the dedicated grant has been lost (or is otherwise missing), the multi-SIM wireless communication device may continue to operate as if the dedicated grant is valid, such as by sending transmissions to the network that include various protocol data units (PDUs). If a valid dedicated grant is confirmed to exist at an end of the detection operations of a testing phase, the multi-SIM wireless communication device may continue to communicate with the network normally. However, if at the end of the testing phase a dedicated grant is determined to be lost or otherwise invalid due to the tune-away, the multi-SIM wireless communication device may repeat acquisition operations and immediately re-transmit any transmission lost after the tune-away. By decreasing lost data transmissions from the multi-SIM wireless communication device as well as use of inappropriate network resources, various embodiments may improve device power efficiency and data reliability, as well as improve overall resource management and interference to networks associated with the subscriptions of the multi-SIM wireless communication device.

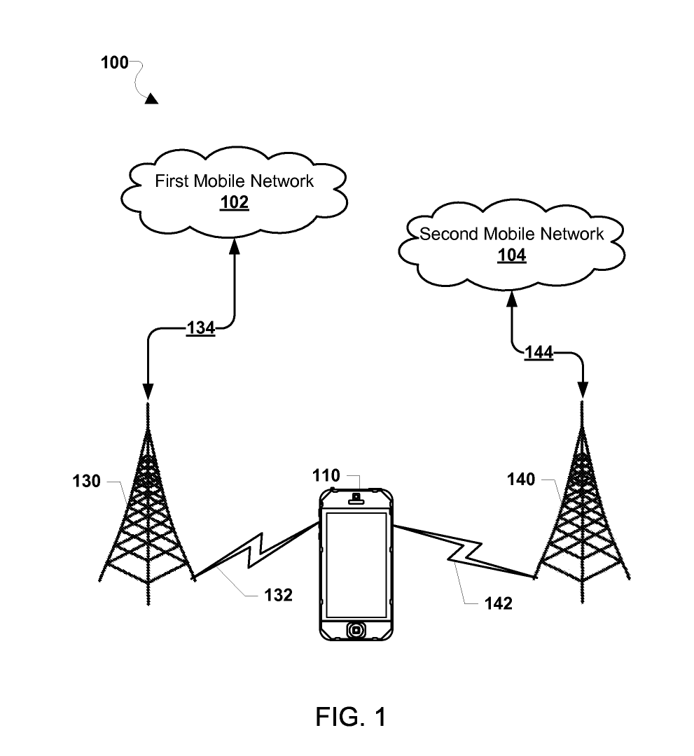

Various embodiments may be implemented within a variety of communication systems 100 that include at least two mobile telephony networks, an example of which is illustrated in FIG. 1. A first mobile network 102 and a second mobile network 104 may typically each include a plurality of cellular base stations (e.g., a first base station 130 and a second base station 140, respectively). The first base station 130 may be in communication with the first mobile network 102 over a wired connection 134. The second base station 140 may be in communication with the second mobile network 104 over a wired connection 144.

A multi-SIM wireless communication device 110 may be configured with a plurality of subscriptions, such as a first subscription corresponding to the first mobile network 102 and a second subscription corresponding to the second mobile network 104. With the respective subscriptions and an RF chain, the multi-SIM wireless communication device 110 may communicate with the first mobile network 102 through a cellular connection 132 to the first base station 130, and may communicate with the second mobile network 104 through a cellular connection 142 to the second base station 140. The cellular connections 132 and 142 may be made through two-way wireless communication links, such as 4G, 3G, Code division multiple access (CDMA), Time division multiple access (TDMA), WCDMA, GSM, and other mobile telephony communication technologies.

As the first and second subscriptions of the multi-SIM wireless communication device 110 are configured to utilize a common RF resource (or RF chain), the multi-SIM wireless communication device 110 may perform tuning-away actions from one subscription to the other, thereby communicating with one of the first mobile network 102 or the second mobile network 104 at any one time.

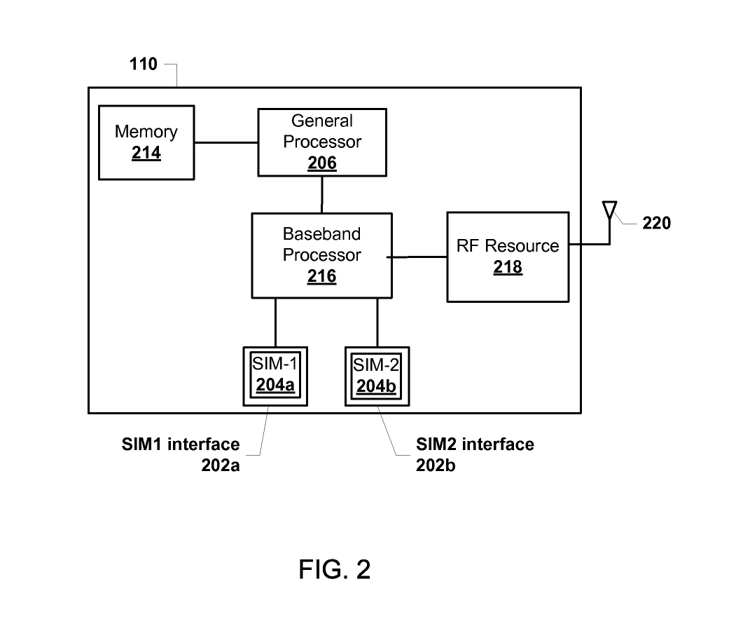

FIG. 2 is a functional block diagram of a multi-SIM wireless communication device 110 (e.g., a dual-subscription, dual standby (DSDS) wireless communication device, etc.) suitable for implementing various embodiments. With reference to FIGS. 1-2, the multi-SIM wireless communication device 110 may include a first SIM interface 202a, which may receive a first subscriber identity module 204a that is associated with a first subscription (referred to as “SIM-1” in FIG. 2). The multi-SIM wireless communication device 110 may also include a second SIM interface 202b, which may receive a second subscriber identity module 204b that is associated with a second subscription (referred to as “SIM-2” in FIG. 2). In some embodiments, either or both of the SIMs 204a, 204b may be implemented within a portion of memory of the multi-SIM wireless communication device 110 (e.g., memory 214), and thus need not be a separate or removable circuits, chips, or cards.

A SIM may be a Universal Integrated Circuit Card (UICC) that is configured with SIM and/or Universal Subscriber Identity Module (USIM) applications, enabling access to, for example, GSM, and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM, and I/O circuits. An Integrated Circuit Card Identity (ICCID) SIM serial number may be printed on the SIM card for identification. Further, a SIM (or SIM card) used in various embodiments may contain user account information, an international mobile subscriber identity (IMSI), a set of SIM application toolkit (SAT) commands, and storage space for phone book contacts. In some embodiments, a SIM card may further store home identifiers (e.g., a System Identification Number (SID)/Network Identification Number (NID) pair, a Home PLMN (HPLMN) code, etc.) to indicate the SIM card network operator provider.

The multi-SIM wireless communication device 110 may include at least one controller, such as a general processor 206 (or applications processor), which may be coupled to various other components, such as a memory 214, a coder/decoder (CODEC), a speaker, a microphone, etc. The memory 214 may be a non-transitory computer-readable storage medium (or non-transitory processor-readable storage medium) that stores processor-executable instructions. For example, the instructions may include routing communication data relating to the first or second subscription though a corresponding baseband-RF resource chain. The memory 214 may store an operating system (OS), as well as user application software and executable instructions. The memory 214 may also store application data, such as an array data structure.

The general processor 206 and the memory 214 may each be coupled to at least one baseband modem processor 216. The SIMs 204a, 204b in the multi-SIM wireless communication device 110 may be associated with a baseband-RF resource chain. A baseband-RF resource chain may include the baseband modem processor 216, which may perform baseband/modem functions for communicating with and/or controlling a RAT, and may include one or more amplifiers and radios, referred to generally as an RF resource 218. The RF resource 218 may provide a radio chain shared by two cellular network subscriptions associated with the two SIMs 204a, 204b.

In some embodiments, the RF resource 218 may be associated with different RATs. For example, a first RAT (e.g., a GSM RAT) and a second RAT (e.g., a Code Division Multiple Access (CDMA) or WCDMA RAT) may be associated with the RF resource 218. The RF resource 218 may be a transceiver that may perform transmit/receive functions on behalf of various RATs. The RF resource 218 may also include separate transmit and receive circuitry, or may include a transceiver that combines transmitter and receiver functions. The RF resource 218 may be coupled to a wireless antenna 220. The RF resource 218 may also be coupled to the baseband modem processor 216.

Functioning together, the two SIMs 204a, 204b, the baseband modem processor 216, the RF resource 218, and the wireless antenna 220 may constitute two or more RATs. For example, a SIM, baseband processor, and RF resource may be configured to support two different RATs, such as GSM and WCDMA. More RATs may be supported on the multi-SIM wireless communication device 110 by adding more SIM cards, SIM interfaces, RF resources, and/or antennae for connecting to additional mobile networks.

In some embodiments, the multi-SIM wireless communication device 110 may include one or more RF resources (e.g., antenna, etc.) that each may be used by one or more subscriptions. For example, multi-SIM wireless communication device 110 may include a plurality of baseband-RF resource chains that may share the baseband modem processor 216 (e.g., a single device that performs baseband/modem functions for all SIMs on the multi-SIM wireless communication device 110). In some embodiments, when the multi-SIM wireless communication device 110 includes a plurality of baseband-RF resource chains, each RF resource chain may include physically or logically separate baseband processors. For example, the multi-SIM wireless communication device 110 may include an optional RF resource coupled to another wireless antenna, such as a Wi-Fi® transceiver coupled to an antenna.

In some embodiments, the general processor 206, the memory 214, the baseband processor(s) 216, and the RF resource 218 may be included in the multi-SIM wireless communication device 110 as a system-on-chip (or “SoC”). In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the multi-SIM wireless communication device 110 may include, but are not limited to, a keypad, a touch screen display, and the microphone. Interfaces may be provided between various software modules and functions in the multi-SIM wireless communication device 110 to enable communication between them, as is known in the art.

While the multi-SIM wireless communication device 110 is shown as supporting two SIMs 204a, 204b sharing one RF resource 218, various embodiments may be implemented on multi-SIM wireless communication devices configured to support more than two SIMs sharing one RF resource 218, as well as on multi-SIM wireless communication devices having two or more RF resources when operating in a mode that supports two or more subscriptions by sharing one RF resource. Multi-SIM wireless communication devices supporting more than two SIMs and subscriptions as well as multi-SIM wireless communication devices having more than one RF resource will include components similar to those of the multi-SIM wireless communication device 110. Thus, the descriptions of various embodiments with reference to two SIMs/subscriptions 204a, 204b sharing one RF resource 218 are not intended to limit the scope of the claims to such devices unless specifically recited in the claims.

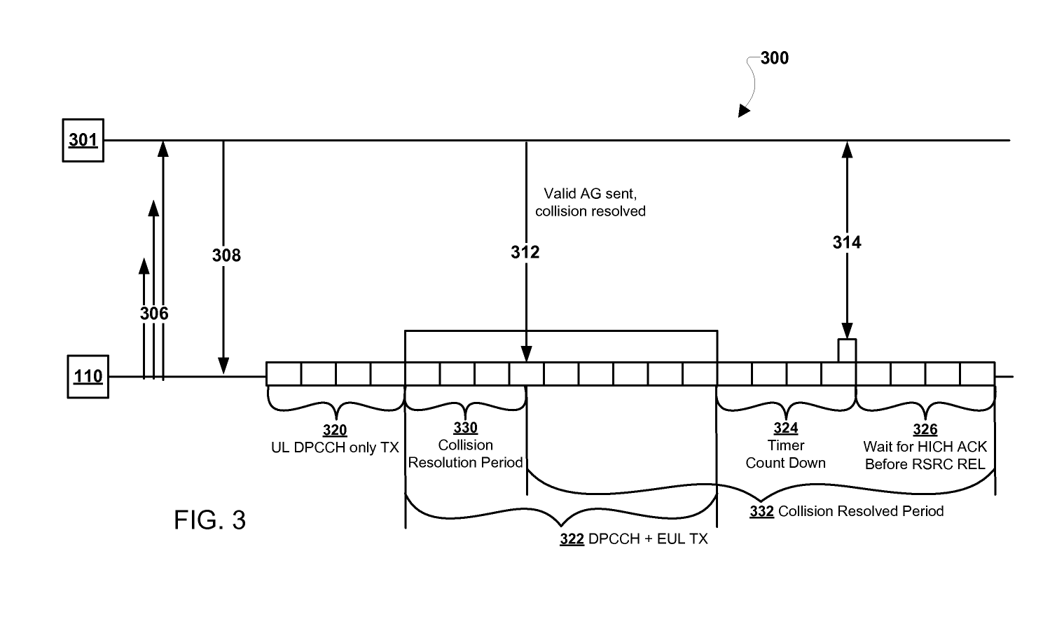

The E-DCH protocol includes several primary operations or periods when providing network access to a subscription of a multi-SIM wireless communication device, including a preamble transmission, a grant acknowledgment, a collision resolution period, a collision resolved period, and a resource release period. FIG. 3 is a diagram 300 illustrating various transmissions that are exchanged between the multi-SIM wireless communication device 110 and a network device 301 (e.g., a server managing cellular network resources, etc.) for requesting, acquiring, using, and releasing network resources with regard to a subscription of a cellular network.

During the beginning of an exemplary E-DCH procedure, the multi-SIM wireless communication device 110 may transmit random access channel (RACH) preamble messages 306. In response, the network device 301 may transmit a positive acknowledgment message 308 (acquisition indication channel (AICH) ACK) that indicates that the preamble messages 306 were received.

When a common E-DCH resource is provided to the multi-SIM wireless communication device 110, the multi-SIM wireless communication device 110 and the network device 301 may enter a first period 320 of exchanging messaging (only transmitting) via an uplink dedicated physical control channel (UL DPCCH). The multi-SIM wireless communication device 110 and the network device 301 may enter a second period 322 of exchanging messaging via a dedicated physical control channel (DPCCH) with enhanced (EUL) uplink transmissions.

During the second period 322, the multi-SIM wireless communication device 110 may use the common E-DCH resource in a collision resolution period 330 during which a dedicated (or absolute) grant is requested from the network device 301. For example, the multi-SIM wireless communication device 110 may use the common E-DCH resource to send a message including a protocol data unit (PDU) indicating the multi-SIM wireless communication device 110 identity and/or data indicating the amount of data the multi-SIM wireless communication device 110 requests to be able to transmit with a dedicated grant. Once the network device 301 determines the amount of data the multi-SIM wireless communication device 110 has to transmit, the network device 301 may transmit the dedicated grant via the AGCH command 312, and the multi-SIM wireless communication device 110 may enter a collision resolved period 332 during which the multi-SIM wireless communication device 110 may utilize the dedicated channel for transmitting data.

During the collision resolved period 332, the multi-SIM wireless communication device 110 may transmit data without an identity included because the channel is dedicated to the multi-SIM wireless communication device 110. The procedure may also include a timer countdown period 324 associated with a transmission continuation offset or timer (e.g., a transport block (TB) timer) that may be configured by the network device 301 in a scheduling information block type 5 (or “SIB 5”). At the end of the timer countdown period 324, scheduling information (SI) that represents a timer expiry may be transmitted by the network device 301, such as a SI-0 message 314 indicating the expiry of the timer configured by the network device 301. The multi-SIM wireless communication device may then wait for a Hybrid Indicator Channel (HICH) acknowledgment (HICH ACK) for a period 326 to release network resources.

As described, tune-aways that occur during particular periods during a network procedure for acquiring/using dedicated grants may cause problems when the dedicated grant is lost, removed, and/or never actually acquired by the multi-SIM wireless communication device 110 for that subscription. In particular, the multi-SIM wireless communication device 110 may encounter such issues when tune-aways occur during the collision resolution period 330, during which time a multi-SIM wireless communication device 110 is awaiting the dedicated grant to a dedicated channel for the subscription, and/or during the collision resolved period 332, during which the subscription has acquired the dedicated grant. For example, when a tune-away occurs during the collision resolved period 332, the multi-SIM wireless communication device 110 may miss a network message indicating that a dedicated grant is no longer reserved for the multi-SIM wireless communication device 110. As another example, when a tune-away occurs during the collision resolution period 330, the multi-SIM wireless communication device 110 may miss receiving the dedicated grant via the AGCH command 312. When such messages are missed, the multi-SIM wireless communication device 110 may make transmissions without authorization from the network device 301, in which case the multi-SIM wireless communication device 110 may transmit without receiving corresponding acknowledgments.

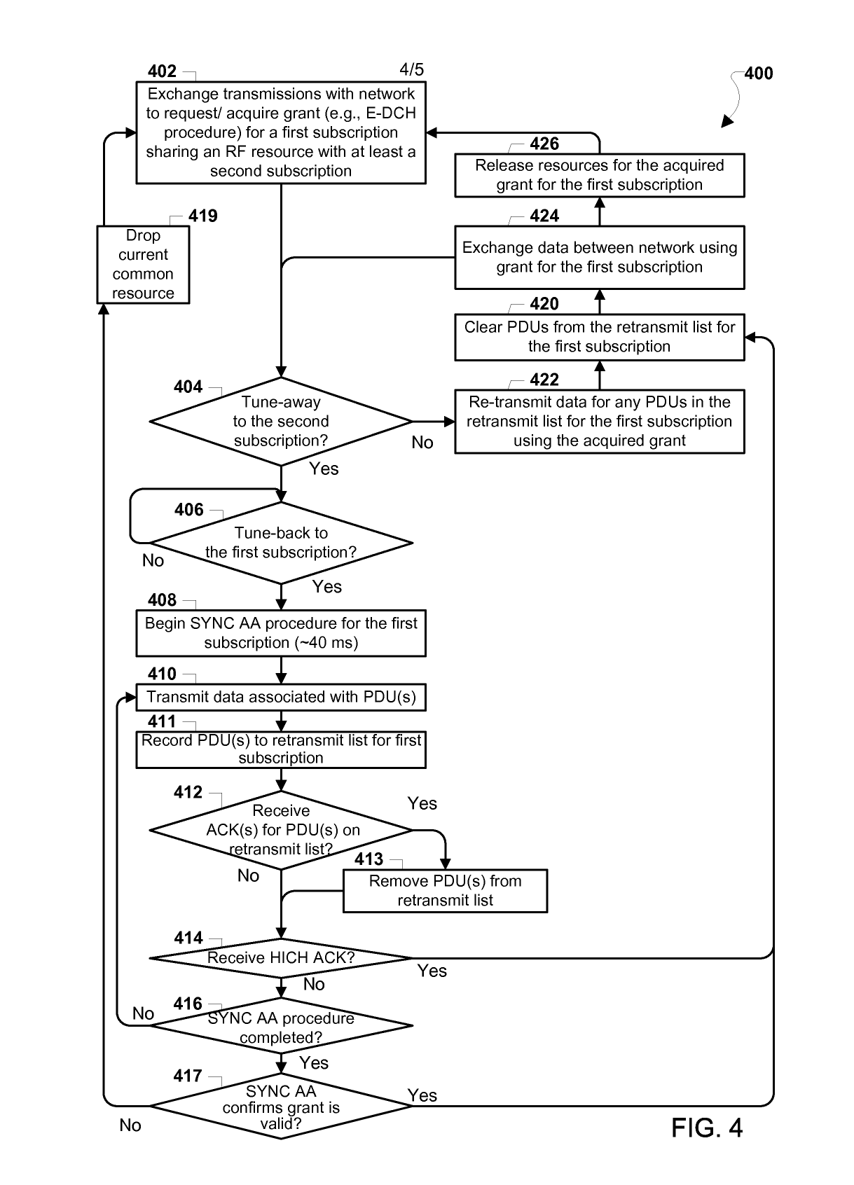

FIG. 4 illustrates a method 400 for resolving network issues that may be caused when a tune-away occurs during certain E-DCH procedure communications according to various embodiments. With reference to FIGS. 1-4, the method 400 may be implemented by a processor (e.g., processor 206) of a multi-SIM wireless communication device (e.g., the multi-SIM wireless communication device 110).

In overview, after requesting a dedicated grant (i.e., an enhanced dedicated channel grant or E-DCH grant) for accessing a network with a first subscription using an enhanced dedicated channel and then subsequently detecting a tune-away from (and tune-back to) the first subscription, the multi-SIM wireless communication device may perform operations during a testing phase of a predetermined enhanced dedicated channel (E-DCH) duration. The multi-SIM wireless communication device may determine whether the dedicated grant is valid based on messages received from the network during the testing phase. For example, the multi-SIM wireless communication device may perform the method 400 to quickly determine whether the grant is still on hold after a tune-away based on the acknowledgement messages (ACK messages) received from the network during a period of a synchronization procedure AA (or “SYNC-AA”) or through the SYNC-AA procedure itself. The SYNC-AA procedure is defined in “Universal Mobile Telecommunications System (UMTS); Physical layer procedures (FDD),” 3GPP TS 25.214 Ver. 12.3.0 Release 12, in section 4.3.2.3A. In this manner, the multi-SIM wireless communication device may determine whether a requested dedicated grant was achieved (e.g., during a collision resolution period) and/or whether AGCH messages were missed that took away a dedicated grant (e.g., during a collision resolved period).

The multi-SIM wireless communication device (e.g., using a processor 206) may exchange transmissions with a network to request and acquire a dedicated grant for a first subscription sharing a radio resource with at least a second subscription of the multi-SIM wireless communication device in block 402. For example, the multi-SIM wireless communication device may exchange messaging with a network device as described (e.g., transmissions 306-312 of FIG. 3, etc.).

In determination block 404, the processor of the multi-SIM wireless communication device may determine whether a tune-away to the second subscription has occurred. In some embodiments, the processor may make this determination based on data available to the operating system and/or a call manager functionality, an interrupt, and/or other event information.

In response to determining that a tune-away has occurred (i.e., determination block 404=“Yes”), the processor of the multi-SIM wireless communication device may determine whether the multi-SIM wireless communication device has tuned back to the first subscription (i.e., a “tune-back” has occurred) in determination block 406. In some embodiments, the processor of the multi-SIM wireless communication device may make this determination based on data available to the operating system and/or a call manager functionality, an interrupt, and/or other event information. So long as the tune-back to the first subscription has not occurred (i.e., determination block 406=“No”), the processor of the multi-SIM wireless communication device may continue to monitor for the tune-back in determination block 406.

In response to determining that a tune-back to the first subscription has occurred (i.e., determination block 406=“Yes”), the processor of the multi-SIM wireless communication device may determine whether a requested and/or already acquired dedicated grant for the first subscription is valid (e.g., acquired without being lost) in the operations of blocks 408-417. The operations in blocks 408-417 may be considered the testing phase during which the multi-SIM wireless communication device detects whether the requested and/or acquired dedicated grant is valid.

In general, once the multi-SIM wireless communication device acquires a dedicated channel for the first subscription, synchronization (SYNC) procedures are continually performed between the multi-SIM wireless communication device and the network. In particular, the multi-SIM wireless communication device may participate in SYNC-AA operations and/or steady-state SYNC operations that indicate whether the multi-SIM wireless communication device is in sync with the network. Such synchronization operations, including the SYNC-AA operations, are defined and described within 3GPP TS 25.214 version 12.3.0 Release 12 (July 2015). The SYNC-AA operations of various embodiments typically conclude in approximately 40 ms, while the steady-state SYNC operations typically conclude in approximately 160 ms. Due to the fast completion time of the SYNC-AA operations, the multi-SIM wireless communication device may leverage the SYNC-AA acknowledgment transmissions from the network to quickly (e.g., within about 40 ms) determine whether there is a valid dedicated grant for accessing the dedicated channel with the first subscription. In other words, the testing phase may coincide with a SYNC-AA procedure.

Thus, in response to determining that a tune-back to the first subscription has occurred (i.e., determination block 406=“Yes”), the processor of the multi-SIM wireless communication device may begin a SYNC-AA procedure for the first subscription in block 408. In some embodiments, the synchronization operations may begin automatically.

While the SYNC-AA procedure operations are being performed, in block 410, the processor of the multi-SIM wireless communication device may cause the multi-SIM wireless communication device to transmit data associated with PDUs while generating a retransmit list of protocol data units (PDUs) indicating data that would need to be retransmitted if the dedicated grant is not valid. In response to or as part of transmitting the data associated with the PDUs, the processor of the multi-SIM wireless communication device may record the PDUs on the retransmit list for the first subscription in block 411. In other words, the processor of the multi-SIM wireless communication device may initially mark for retransmission all the transmissions with PDUs that are transmitted during the testing phase corresponding to the SYNC-AA period (e.g., within 40 ms). In some embodiments, the PDUs may be Layer 2 PDUs. Proceeding to transmit without first confirming a dedicated grant allows the multi-SIM wireless communication device to avoid delays and/or losing time in the event that the dedicated grant is valid. However, as the dedicated grant may not be valid (e.g., the dedicated grant was lost or never acquired), the processor of the multi-SIM wireless communication device may record data, such as in the retransmit list of PDUs, that may be used to recover lost data transmissions using this timesaving procedure when the dedicated grant is invalid.

As there is uncertainty of the data transmissions associated with the PDUs during the SYNC-AA procedure, the processor of the multi-SIM wireless communication device may be configured to detect the receipt of any ACK messages corresponding to PDUs of the transmitted data. Accordingly, in determination block 412, the processor of the multi-SIM wireless communication device may determine whether any ACK messages have been received that correspond to (or are associated with) PDUs recorded on the retransmit list for the first subscription. Any transmissions (and associated PDUs) that do not receive acknowledgments (e.g., ACK messages) during the SYNC-AA procedure (i.e., during the testing phase) may be candidates for later re-transmission. For example, not receiving an ACK message related to a certain PDU during the SYNC-AA procedure may indicate that the already transmitted message associated with that PDU was not received by the network.

In some embodiments, the processor of the multi-SIM wireless communication device may also detect whether negative-acknowledgement (NACK) messages (e.g., messages including a negative-acknowledgement character) are received that are associated with PDUs of the data that were transmitted in block 410. Receipt of a NACK message including, listing, or otherwise identifying a particular PDU may indicate to the multi-SIM wireless communication device that a previous transmission associated with that PDU was not successfully received by the network. For example, in response to detecting the receipt of a HARQ NACK message related to a certain PDU, the processor of the multi-SIM wireless communication device may determine that a previously transmitted message associated with that PDU was unsuccessfully received by the network. Thus, that PDU should be entered or otherwise remain on the retransmit list as a candidate for retransmission.

In response to determining that one or more ACK messages corresponding to PDUs recorded on the retransmit list for the first subscription have been received (i.e., determination block 412=“Yes”), the processor of the multi-SIM wireless communication device may remove the PDUs associated with the received ACK messages from the retransmit list for the first subscription in block 413.

In response to determining that no ACK messages corresponding to PDUs recorded on the retransmit list for the first subscription have been received (i.e., determination block 412=“No”), or in response to performing the operations in block 413, the processor of the multi-SIM wireless communication device may determine whether a positive acknowledgement message (or HICH ACK) is received in determination block 414. For example, if any HICH ACKs are received during the SYNC-AA, the processor of the multi-SIM wireless communication device may determine that there is a valid dedicated grant to the dedicated channel. In some embodiments, the multi-SIM wireless communication device may receive a HICH ACK within between 7.5 ms-16 ms after returning from a tune-away, and thus the processor may confirm that a dedicated grant is valid faster than if the processor only evaluated the success or failure of the SYNC-AA operations (which may take 40 ms).

In response to determining that the HICH ACK message is not received (i.e., determination block 414=“No”), the processor of the multi-SIM wireless communication device may determine whether the SYNC-AA procedure has completed in determination block 416. For example, the multi-SIM wireless communication device may determine whether 40 ms have elapsed corresponding to the typical SYNC-AA procedure completion time/runtime. In response to determining that the SYNC-AA procedure has not completed (i.e., determination block 416=“No”), the processor of the multi-SIM wireless communication device may continue to cause the multi-SIM wireless communication device to transmit additional data associated with PDUs (if any) in block 410 as described.

In response to determining that the SYNC-AA procedure has completed (i.e., determination block 416=“Yes”), the processor of the multi-SIM wireless communication device may determine whether the dedicated grant is confirmed as valid based on the SYNC-AA procedure in determination block 417.

In response to determining that the dedicated grant is not confirmed as valid based on the SYNC-AA procedure (i.e., determination block 417=“No”), the processor of the multi-SIM wireless communication device may drop any currently used (or otherwise acquired) common E-DCH resource in block 419 and start the dedicated grant acquisition process over from the beginning in block 402. For example, the multi-SIM wireless communication device may exchange transmissions with the network to request a second enhanced dedicated channel grant in response to determining that a first enhanced dedicated channel grant is not valid for the first subscription. In this way, the multi-SIM wireless communication device may take action to promptly acquire a new, valid dedicated grant that may be used to retransmit any transmissions associated with PDUs recorded in the retransmit list for the first subscription (e.g., data transmitted via operations in block 410 for which no ACKs were received or detected with the operations in determination block 412). For example, when no HICH ACKs are received and the SYNC-AA procedure determines that the dedicated grant is invalid (e.g., because a dedicated grant was not received or was cancelled during the tune-away), the processor of the multi-SIM wireless communication device may immediately repeat the operations to request another enhanced dedicated channel grant (e.g., providing new preamble transmissions, etc.).

In response to determining that the dedicated grant is confirmed as valid based on the SYNC-AA procedure (i.e., determination block 417=“Yes”) or in response to determining that a HICH ACK is received (i.e., determination block 414=“Yes”), the processor of the multi-SIM wireless communication device may clear any PDUs from the retransmit list for the first subscription in block 420. Clearing the PDUs from the retransmit list may include removing data associated with the PDUs (and/or the list of PDUs) from memory. Clearing the retransmit list of PDUs can be performed because determining that the dedicated grant is valid indicates that the data transmitted during the SYNC-AA procedure was received over the dedicated channel. In block 424, the processor of the multi-SIM wireless communication device may exchange data with the network using the dedicated grant for the first subscription. The multi-SIM wireless communication device may also monitor for either a tune away to the second subscription (e.g., operations in determination block 404) and/or monitor for conditions indicating that the dedicated resources should be released, causing the multi-SIM wireless communication device to perform the operations of block 426.

In response to determining that no tune-away has occurred since the exchange of transmissions to acquire a dedicated grant in block 402 (i.e., determination block 404=“No”), the processor of the multi-SIM wireless communication device may re-transmit data for any PDUs in the retransmit list for the first subscription using the acquired dedicated grant in block 422. For example, after performing operations of a testing phase that determined a first enhanced dedicated channel grant was not valid, the multi-SIM wireless communication device may obtain a new enhanced dedicated channel grant and re-transmit data transmissions associated with PDUs on a list of PDUs recorded during the testing phase.

In circumstances in which the exchange of transmissions to acquire a dedicated grant in block 402 was performed after the processor of the multi-SIM wireless communication device determined that the dedicated grant was not confirmed to be valid based on the SYNC-AA procedure (i.e., determination block 417=“No”), the PDU re-transmit list will include the PDUs transmitted in block 410. Thus, with a dedicated grant established, the retransmission list can be used to recover from presumptively transmitting PDUs before confirming whether the dedicated grant is valid (i.e., transmitted during the previous test phase). On the other hand, in other circumstances, the PDU re-transmit list may be empty, and thus no retransmissions will be required in block 422.

After (or in parallel with) re-transmitting PDUs in the retransmit list in block 422, the processor of the multi-SIM wireless communication device may clear from memory (e.g., 214) PDUs on the retransmit list for the first subscription in block 420, and continue exchanging data with the network using the dedicated grant (e.g., original dedicated grant, re-acquired dedicated grant, etc.) for the first subscription in block 424 as described.

In block 426, the processor of the multi-SIM wireless communication device may release resources for the dedicated grant for the first subscription, such as when the resources for the dedicated grant have been used.

The operations of the method 400 may be performed in loop with the multi-SIM wireless communication device again exchanging transmissions with a network to request and acquire a dedicated grant for the first subscription in block 402. Additionally, while exchanging data between the multi-SIM wireless communication and the network in block 424, the processor of the multi-SIM wireless communication device may monitor for the conduct of a tune-away to the second subscription in determination block 404. In response to determining that a tune-away has occurred (i.e., determination block 404=“Yes”) the processor of the multi-SIM wireless communication device may repeat the operations in blocks 406-417 to determine whether the network has revoked the dedicated grant and proceed as described.

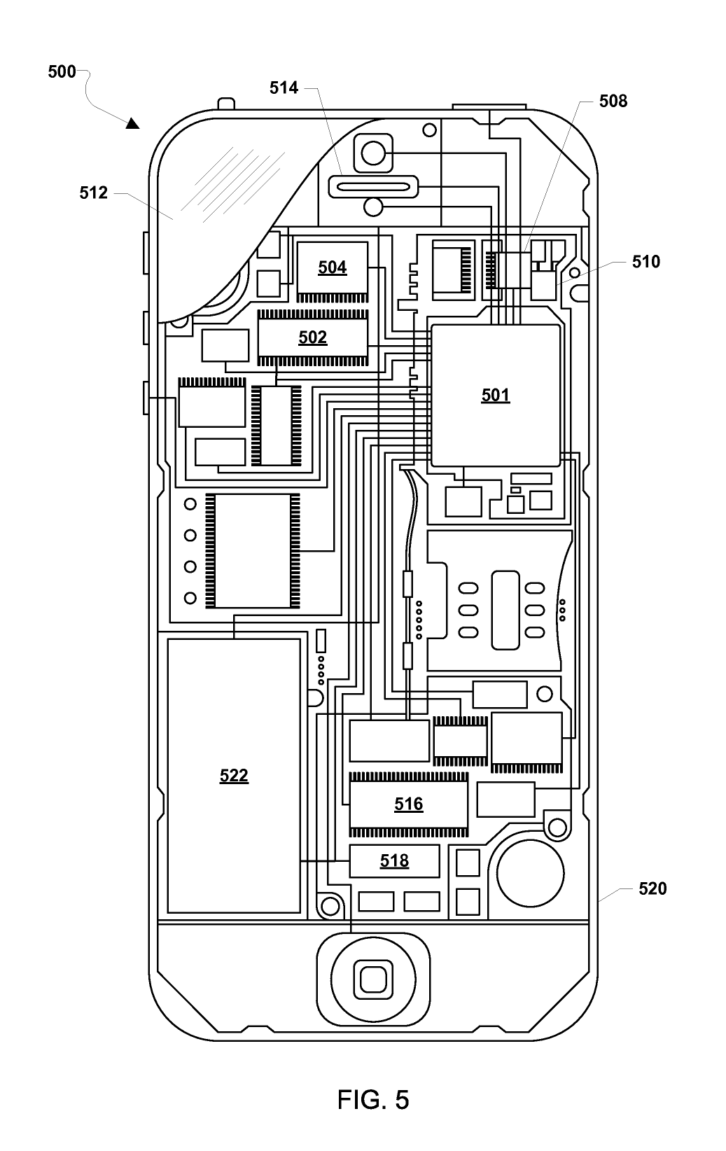

Various forms of computing devices, including personal computers and laptop computers, may be used to implement various embodiments. Such computing devices typically include the components illustrated in FIG. 5, which illustrates an example multi-core wireless communication device 500.

In various embodiments, the wireless communication device 500 may include a processor 501 coupled to a touch screen controller 504 and an internal memory 502. The processor 501 may be one or more multi-core ICs designated for general or specific processing tasks. The internal memory 502 may be volatile or non-volatile memory, and may also be secure and/or encrypted memory, or unsecure and/or unencrypted memory, or any combination thereof. The touch screen controller 504 and the processor 501 may also be coupled to a touch screen panel 512, such as a resistive-sensing touch screen, capacitive-sensing touch screen, infrared sensing touch screen, etc.

The wireless communication device 500 may have one or more radio signal transceivers 508 (e.g., Bluetooth®, ZigBee®, Wi-Fi®, RF radio) and antennae 510, for sending and receiving, coupled to each other and/or to the processor 501. The transceivers 508 and antennae 510 may be used with the above-mentioned circuitry to implement various wireless transmission protocol stacks and interfaces. The wireless communication device 500 may include a cellular network wireless modem chip 516 that enables communication via a cellular network and is coupled to the processor.

The wireless communication device 500 may include a peripheral device connection interface 518 coupled to the processor 501. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown). The wireless communication device 500 may also include speakers 514 for providing audio outputs. The wireless communication device 500 may also include a housing 520, constructed of a plastic, metal, or a combination of materials, for containing all or some of the components discussed herein. The wireless communication device 500 may include a power source 522 coupled to the processor 501, such as a disposable or rechargeable battery. The rechargeable battery may also be coupled to the peripheral device connection port to receive a charging current from a source external to the wireless communication device 500.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

Various processors described herein may be any programmable microprocessor, microcomputer or multiple processor chip or chips that can be configured by software instructions (applications) to perform a variety of functions, including the functions of various embodiments described herein. In various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into various devices and memory within the processors.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory processor-readable, computer-readable, or server-readable medium or a non-transitory processor-readable storage medium. The operations of a method or algorithm disclosed herein may be embodied in a processor-executable software module or processor-executable software instructions, which may reside on a non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray Disc® where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the embodiment techniques of the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a processor of a multi-Subscription Identity Module (SIM) wireless communication device for managing data exchanges with a network when an enhanced dedicated channel grant for an enhanced dedicated channel is requested on a first subscription, comprising:
transmitting data using the enhanced dedicated channel for the first subscription during a testing phase that occurs after performing a tune-away to a second subscription;
recording a retransmit list of protocol data units (PDUs) corresponding to data transmitted using the enhanced dedicated channel during the testing phase;
determining whether the enhanced dedicated channel grant for the enhanced dedicated channel is valid for the first subscription by an end of the testing phase;
clearing the retransmit list of PDUs in response to determining that the enhanced dedicated channel grant is valid for the first subscription;
exchanging data with the network in response to determining that the enhanced dedicated channel grant is valid for the first subscription; and
exchanging transmissions with the network to request a second enhanced dedicated channel grant in response to determining that the enhanced dedicated channel grant is not valid for the first subscription.

2. The method of claim 1, wherein the testing phase coincides with a SYNC-AA procedure.

3. The method of claim 2, wherein the SYNC-AA procedure has a duration of 40 ms.

4. The method of claim 2, wherein determining whether the enhanced dedicated channel grant is valid for the first subscription comprises:
determining whether a Hybrid Indicator Channel acknowledgment (HICH ACK) message is received corresponding to the first subscription during the testing phase;
determining that the enhanced dedicated channel grant is valid in response to determining that that a HICH ACK message is received corresponding to the first subscription during the testing phase; and
completing the SYNC-AA procedure in response to determining that a HICH ACK message is not received corresponding to the first subscription during the testing phase.

5. The method of claim 1, further comprising:
re-transmitting data associated with PDUs on the retransmit list of PDUs after the second enhanced dedicated channel grant is received following exchanges of transmissions with the network to request the second enhanced dedicated channel grant in response to determining that the enhanced dedicated channel grant was not valid for the first subscription; and
clearing the retransmit list of PDUs.

6. The method of claim 1, further comprising:
determining whether any acknowledge (ACK) messages associated with PDUs on the retransmit list of PDUs have been received during the testing phase; and
removing from the retransmit list of PDUs the PDUs associated with ACK messages that are determined to have been received during the testing phase.

7. The method of claim 1, further comprising:
dropping any currently used common enhanced dedicated channel (E-DCH) resource in response to determining that the enhanced dedicated channel grant is not valid for the first subscription.

8. The method of claim 1, further comprising:
releasing resources for the enhanced dedicated channel grant for the first subscription in response to exchanging the data with the network using the enhanced dedicated channel grant for the first subscription.

9. A multi-Subscription Identity Module (SIM) wireless communication device, comprising:
a memory; and
a processor coupled to the memory and configured with processor-executable instructions to:
transmit data using an enhanced dedicated channel for a first subscription during a testing phase that occurs after performing a tune-away to a second subscription;
record a retransmit list of protocol data units (PDUs) corresponding to data transmitted using the enhanced dedicated channel during the testing phase;
determine whether an enhanced dedicated channel grant for the enhanced dedicated channel is valid for the first subscription by an end of the testing phase;
clear the retransmit list of PDUs in response to determining that the enhanced dedicated channel grant is valid for the first subscription;
exchange data with a network in response to determining that the enhanced dedicated channel grant is valid for the first subscription; and
exchange transmissions with the network to request a second enhanced dedicated channel grant in response to determining that the enhanced dedicated channel grant is not valid for the first subscription.

10. The multi-SIM wireless communication device of claim 9, wherein the testing phase coincides with a SYNC-AA procedure.

11. The multi-SIM wireless communication device of claim 10, wherein the SYNC-AA procedure has a duration of 40 ms.

12. The multi-SIM wireless communication device of claim 10, wherein the processor is further configured with processor-executable instructions to determine whether the enhanced dedicated channel grant is valid for the first subscription by:
determining whether a Hybrid Indicator Channel acknowledgment (HICH ACK) message is received corresponding to the first subscription during the testing phase;
determining that the enhanced dedicated channel grant is valid in response to determining that that a HICH ACK message is received corresponding to the first subscription during the testing phase; and
completing the SYNC-AA procedure in response to determining that a HICH ACK message is not received corresponding to the first subscription during the testing phase.

13. The multi-SIM wireless communication device of claim 9, wherein the processor is further configured with processor-executable instructions to:
re-transmit data associated with PDUs on the retransmit list of PDUs after the second enhanced dedicated channel grant is received following exchanges of transmissions with the network to request the second enhanced dedicated channel grant in response to determining that the enhanced dedicated channel grant was not valid for the first subscription; and
clear the retransmit list of PDUs.

14. The multi-SIM wireless communication device of claim 9, wherein the processor is further configured with processor-executable instructions to:
determine whether any acknowledge (ACK) messages associated with PDUs on the retransmit list of PDUs have been received during the testing phase; and
remove from the retransmit list of PDUs the PDUs associated with ACK messages that are determined to have been received during the testing phase.

15. The multi-SIM wireless communication device of claim 9, wherein the processor is further configured with processor-executable instructions to:
drop any currently used common enhanced dedicated channel (E-DCH) resource in response to determining that the enhanced dedicated channel grant is not valid for the first subscription.

16. The multi-SIM wireless communication device of claim 9, wherein the processor is further configured with processor-executable instructions to:
release resources for the enhanced dedicated channel grant for the first subscription in response to exchanging the data with the network using the enhanced dedicated channel grant for the first subscription.

17. A non-transitory processor-readable storage medium having stored thereon processor-executable instructions configured to cause a processor of a multi-Subscription Identity Module (SIM) wireless communication device to perform operations comprising:
transmitting data using an enhanced dedicated channel for a first subscription during a testing phase that occurs after performing a tune-away to a second subscription;
recording a retransmit list of protocol data units (PDUs) corresponding to data transmitted using the enhanced dedicated channel during the testing phase;
determining whether an enhanced dedicated channel grant for the enhanced dedicated channel is valid for the first subscription by an end of the testing phase;
clearing the retransmit list of PDUs in response to determining that the enhanced dedicated channel grant is valid for the first subscription;
exchanging data with a network in response to determining that the enhanced dedicated channel grant is valid for the first subscription; and
exchanging transmissions with the network to request a second enhanced dedicated channel grant in response to determining that the enhanced dedicated channel grant is not valid for the first subscription.

18. The non-transitory processor-readable storage medium of claim 17, wherein the testing phase coincides with a SYNC-AA procedure.

19. The non-transitory processor-readable storage medium of claim 18, wherein the SYNC-AA procedure has a duration of 40 ms.

20. The non-transitory processor-readable storage medium of claim 18, wherein the stored processor-executable instructions are configured to cause the processor to perform operations such that determining whether the enhanced dedicated channel grant is valid for the first subscription comprises:
determining whether a Hybrid Indicator Channel acknowledgment (HICH ACK) message is received corresponding to the first subscription during the testing phase;
determining that the enhanced dedicated channel grant is valid in response to determining that that a HICH ACK message is received corresponding to the first subscription during the testing phase; and
completing the SYNC-AA procedure in response to determining that a HICH ACK message is not received corresponding to the first subscription during the testing phase.

21. The non-transitory processor-readable storage medium of claim 17, wherein the stored processor-executable instructions are configured to cause the processor to perform operations further comprising:
re-transmitting data associated with PDUs on the retransmit list of PDUs after the second enhanced dedicated channel grant is received following exchanges of transmissions with the network to request the second enhanced dedicated channel grant in response to determining that the enhanced dedicated channel grant was not valid for the first subscription; and
clearing the retransmit list of PDUs.

22. The non-transitory processor-readable storage medium of claim 17, wherein the stored processor-executable instructions are configured to cause the processor to perform operations further comprising:
determining whether any acknowledge (ACK) messages associated with PDUs on the retransmit list of PDUs have been received during the testing phase; and
removing from the retransmit list of PDUs the PDUs associated with ACK messages that are determined to have been received during the testing phase.

23. The non-transitory processor-readable storage medium of claim 17, wherein the stored processor-executable instructions are configured to cause the processor to perform operations further comprising:
dropping any currently used common enhanced dedicated channel (E-DCH) resource in response to determining that the enhanced dedicated channel grant is not valid for the first subscription.

24. The non-transitory processor-readable storage medium of claim 17, wherein the stored processor-executable instructions are configured to cause the processor to perform operations further comprising:
releasing resources for the enhanced dedicated channel grant for the first subscription in response to exchanging the data with the network using the enhanced dedicated channel grant for the first subscription.

25. A multi-Subscription Identity Module (SIM) wireless communication device, comprising:
means for transmitting data using an enhanced dedicated channel for a first subscription during a testing phase that occurs after performing a tune-away to a second subscription;
means for recording a retransmit list of protocol data units (PDUs) corresponding to data transmitted using the enhanced dedicated channel during the testing phase;
means for determining whether an enhanced dedicated channel grant for the enhanced dedicated channel is valid for the first subscription by an end of the testing phase;
means for clearing the retransmit list of PDUs in response to determining that the enhanced dedicated channel grant is valid for the first subscription;
means for exchanging data with a network in response to determining that the enhanced dedicated channel grant is valid for the first subscription; and
means for exchanging transmissions with the network to request a second enhanced dedicated channel grant in response to determining that the enhanced dedicated channel grant is not valid for the first subscription.

26. The multi-SIM wireless communication device of claim 25, wherein the testing phase coincides with a SYNC-AA procedure.

27. The multi-SIM wireless communication device of claim 26, wherein the SYNC-AA procedure has a duration of 40 ms.

28. The multi-SIM wireless communication device of claim 26, wherein means for determining whether the enhanced dedicated channel grant is valid for the first subscription comprises:
means for determining whether a Hybrid Indicator Channel acknowledgment (HICH ACK) message is received corresponding to the first subscription during the testing phase;
means for determining that the enhanced dedicated channel grant is valid in response to determining that that a HICH ACK message is received corresponding to the first subscription during the testing phase; and
means for completing the SYNC-AA procedure in response to determining that a HICH ACK message is not received corresponding to the first subscription during the testing phase.

29. The multi-SIM wireless communication device of claim 25, further comprising:
means for re-transmitting data associated with PDUs on the retransmit list of PDUs after the second enhanced dedicated channel grant is received following exchanges of transmissions with the network to request the second enhanced dedicated channel grant in response to determining that the enhanced dedicated channel grant was not valid for the first subscription; and
means for clearing the retransmit list of PDUs.

30. The multi-SIM wireless communication device of claim 25, further comprising:
means for determining whether any acknowledge (ACK) messages associated with PDUs on the retransmit list of PDUs have been received during the testing phase; and
means for removing from the retransmit list of PDUs the PDUs associated with ACK messages that are determined to have been received during the testing phase.
